(19) United States
(12) Patent Application Publication
(10) Pub. No.: US 2016/0062517 A1
(43) Pub. Date: Mar. 3, 2016

(54) Multi-Layer Transparent Force Sensor

(71) Applicant: Apple Inc., Cupertino, CA (US)

(72) Inventors: David J. Meyer, Chicago, IL (US); James E. Pedder, Cupertino, CA (US); John Z. Zhong, Cupertino, CA (US); Sunggu Kang, Cupertino, CA (US)

(21) Appl. No.: 14/842,402

(22) Filed: Sep. 1, 2015

Related U.S. Application Data
(60) Provisional application No. 62/044,874, filed on Sep. 2, 2014.

(51) Int. Cl. G06F 3/045

(52) U.S. Cl. CPC G06F 3/045; G06F 2203/04103

(57) ABSTRACT

An optically transparent force sensor element includes multi-layer electrodes of two materials having different gauge factors to increase sensitivity of measured force magnitude. A passivation layer is positioned between the electrode layers in each element. One gauge factor may be positive while the other gauge factor may be negative.

### CROSS-REFERENCE TO RELATED APPLICATION

This application claims the benefit under 35 U.S.C. §119(e) to U.S. Provisional Application No. 62/044,874, filed Sep. 2, 2014, entitled “Multi-Layer Transparent Force Sensor, the disclosure of which is hereby incorporated herein by reference in its entirety.

### FIELD

Embodiments described herein generally relate to force sensing along a surface and, more particularly, to force sensing at a surface using a transparent force-sensitive film integrated within a display element of an electronic device.

### BACKGROUND

Many electronic devices may include a touch sensitive surface for receiving user input. Example devices which may utilize a touch sensitive surface may include cellular telephones, smart phones, personal digital assistants, tablet computers, laptop computers, track pads, wearable devices, health devices, sports accessory devices, peripheral input devices, and so on. The touch sensitive surface may detect and relay the location of one or more user touches which may be interpreted by the electronic device as a command or a gesture. In one example, the touch input may be used to interact with a graphical user interface. In another example, the touch input may be relayed to an application program operating on a computer system to implement the application program.

However, touch sensitive surfaces are limited to providing only the location of one or more touch events. Touch, like many present inputs for computing devices, is binary. The touch is present or it is not. Binary inputs are inherently limited insofar as they can only occupy two states (present or absent, on or off, and so on). In many examples, it may be advantageous to also detect and measure the force of a touch that is applied to a surface. In addition, if the force can be measured across a continuum of values, it can function as a non-binary input. Further, the combination of touch input and force input may provide certain advantages over the use of either alone.

Accordingly, there may be a present need for an improved input surface capable to detect and relay the magnitude of the force applied at one or more user touch locations.

### SUMMARY

Embodiments described herein may relate to, include, or take the form of a force sensor for use as input to an electronic device. In certain embodiments, the optically transparent force sensor may include at least a force-receiving surface, a first and second substrate each comprising an optically transparent material, and each substrate including respectively a first and second force-sensitive film. In each force-sensitive film there may be multiple material layers with opposite sign gauge factors to increase signal strength. In some examples, the first substrate may be disposed below the force-receiving surface such that the first force-sensitive film may experience a tensile force upon an application of force and deflection of the force-receiving surface.

The substrates may be coupled to one another by an adhesive layer made from a thermally conductive and mechanically compliant material. As a result of the thermal conductivity of the adhesive layer, the temperature of the first and second force-sensitive film may be substantially equalized. However, due to the compliance of the material selected for the adhesive layer, the force experienced by the first and second force-sensitive films may be substantially different. In some examples, the adhesive layer may have a shear modulus less than the shear modulus of the first substrate (for example, one tenth as much). In this manner, the force experienced by the first force-sensitive film at a certain temperature may be greater than the force experienced by the second force-sensitive film at the same temperature.

In many examples, the first and second force-sensitive films, the first and second substrates, and the adhesive therebetween may be made from an optically transparent material. For example, the substrates may be made from glass and the force-sensitive films may be made from indium-tin oxide, nanowire, carbon nanotubes, graphene, piezoresistive semiconductors, or piezoresistive metals. In certain embodiments, the optically transparent material may be a polymer layer, for example acrylic, epoxy, polyurethane or various types of silicone. The optically transparent material may be curable by ultraviolet light, a snap cure, an ultraviolet curing process, heat curing, moisture curing, or combinations thereof. The optically transparent material may be a pressure sensitive film or tape, or a liquid adhesive, or may be a composite of layers including bonding layers, strain relief layers and index matching layers.

In one embodiment including two layers of transparent conductive electrodes (TCE), each TCE layer may include two different layers of force sensing material having differing gauge factors. In one embodiment, the two gauge factors are of opposite sign, one positive and one negative, in order to increase the sensitivity of the strain gauge. In another embodiment, only one TCE layer is used with two different force sensing materials in the one layer. The change in resistance of each material due to force is measured and the gauge equation for each material is solved simultaneously with the other to obtain the magnitude of the strain.

### BRIEF DESCRIPTION OF THE DRAWINGS

Reference will now be made to representative embodiments illustrated in the accompanying figures. It should be understood that the following descriptions are not intended to limit the embodiments to one preferred embodiment. To the contrary, it is intended to cover alternatives, modifications, and equivalents as may be included within the spirit and scope of the described embodiments as defined by the appended claims.

FIG. 1 depicts an example electronic device incorporating at least one transparent force sensor;

FIG. 2A depicts a top view of an example force-sensitive structure including a grid of optically transparent force-sensitive films;

FIG. 2B depicts a top detailed view of an optically transparent serpentine force-sensitive film which may be used in the example force-sensitive structure depicted in FIG. 2A;

FIG. 2C depicts a side view of a portion of the example force-sensitive structure of FIG. 2A taken along line 2-2;

FIG. 3A depicts an enlarged detail side view of the example force-sensitive structure of FIG. 2B taken along line 3-3;

FIG. 3B depicts an enlarged detail side view of the example force-sensitive structure of FIG. 2B taken along line 3-3, deformed in response to an applied force;

FIG. 4 depicts a Wheatstone Bridge used to measure electrical resistance changes in one embodiment;

FIG. 5A depicts an enlarged detail side view of one embodiment of force-sensitive structure of FIG. 2B taken along line 3-3;

FIG. 5B depicts an enlarged detail side view of one embodiment of force-sensitive structure of FIG. 2B taken along line 3-3, deformed in response to an applied force;

FIG. 6A depicts an enlarged detail side view of an alternate embodiment of force-sensitive structure of FIG. 2B taken along line 3-3;

FIG. 6B depicts an enlarged detail side view of an alternate embodiment of force-sensitive structure of FIG. 2B taken along line 3-3, deformed in response to an applied force;

FIG. 7 is a process flow diagram illustrating example steps of a method of manufacturing a temperature-compensating and optically transparent force sensor;

FIG. 8 is a process flow diagram illustrating example steps of a method of operating a temperature-compensating force sensor; and

FIG. 9 is a process flow diagram illustrating example steps of an alternate embodiment of a method of operating a temperature-compensating force sensor.

### DETAILED DESCRIPTION

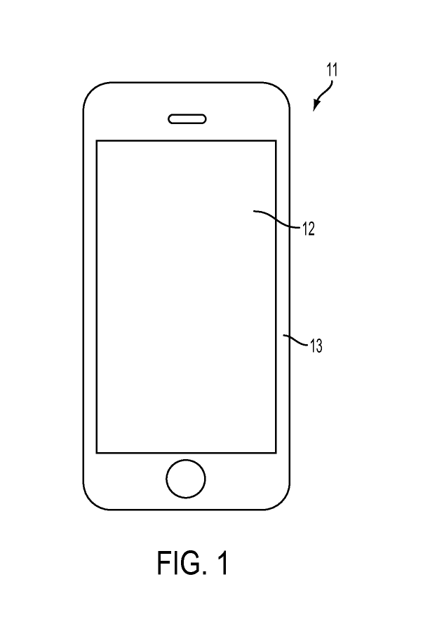

Reference will now be made in detail to representative embodiments illustrated in the accompanying drawings wherein like reference numerals denote like structure throughout each of the various figures. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims. These and other embodiments are discussed below with reference to FIGS. 1-9.

Embodiments described herein may relate to or take the form of temperature-compensating optically transparent force sensors for receiving user input to an electronic device. Certain embodiments described herein also relate to force-sensitive structures including one or more force-sensitive films for detecting a magnitude of a force applied to a device. In one example, a transparent force-sensitive film is integrated with, or adjacent to, a display element of an electronic device. The electronic device may be, for example, a mobile phone, a tablet computing device, a computer display, a computing input device (such as a touch pad, keyboard, or mouse), a wearable device such as a watch or glasses, a health monitor device, a sports accessory device, and so on.

Generally and broadly, a user touch event may be sensed on a display, enclosure, or other surface associated with an electronic device using a force sensor adapted to determine the magnitude of force of the touch event. The determined magnitude of force may be used as an input signal, input data, or other input information to the electronic device. In one example, a high force input event may be interpreted differently from a low force input event. For example, a smart phone may unlock a display screen with a high force input event and may pause audio output for a low force input event. The device's responses or outputs may thus differ in response to the two inputs, even though they occur at the same point and may use the same input device. In further examples, a change in force may be interpreted as an additional type of input event. For example, a user may hold a wearable device force sensor proximate to an artery in order to evaluate blood pressure or heart rate. A force sensor may thus be used for collecting a variety of user inputs.

In many examples, a force sensor may be incorporated into a touch-sensitive electronic device and located above a display of the device, or incorporated into a display stack. Accordingly, in such embodiments, the force sensor may be constructed of optically transparent materials. For example, an optically transparent force sensor may include at least a force-receiving surface, a first and second substrate each comprising an optically transparent material, and each substrate including respectively a first and second force-sensitive film. In many examples, the first substrate may be disposed below the force-receiving surface such that the first force-sensitive film may experience deflection, compression, or another mechanical deformation upon application of force to the force-receiving surface. In this manner, a bottom surface of the first substrate may experience an expansion and a top surface of the first substrate may experience a compression. In other words, the first substrate may bend about its neutral axis, experiencing compressive and tensile forces.

A transparent force-sensitive film is typically a compliant material that exhibits at least one electrical property that is variable in response to deformation, deflection, or shearing of the film. The transparent force-sensitive film may be formed from a piezoelectric, piezoresistive, resistive, or other strain-sensitive materials. Transparent force-sensitive films can be formed by coating a substrate with a transparent conductive material or otherwise depositing such a material on the substrate. In many examples, the force-sensitive films may be formed about the bottom surface of the first substrate and along a top surface of a second substrate. The force sensitive films of the first and second substrates may be oriented to face one another. In this manner, when the top substrate deflects and the bottom surface expands under tension, the transparent force sensitive film may also expand, stretch, or otherwise geometrically change as a result of the tensile forces. One may appreciate that the force-sensitive film may be under tension because it is positioned below the neutral axis of the bend of the first substrate.

Once under tension, the transparent force-sensitive film may exhibit a change in at least one electrical property, for example, resistance. In one example, the resistance of the transparent force-sensitive film may increase linearly with an increase in tension experienced by the film. In another example, the resistance of the transparent force-sensitive film may decrease linearly with an increase in tension experienced by the film. Different transparent materials may experience different changes to different electrical properties, and as such, the effects of tension may vary from one embodiment to another.

Suitable transparent conductive materials include, for example, polyethyleneioxythiophene (PEDOT), indium tin oxide (ITO), carbon nanotubes, graphene, silver nanowire, other metallic nanowires, and the like. Potential substrate materials include, for example, glass or transparent polymers like polyethylene terephthalate (PET) or cyclo-olefin polymer (COP). Typically, when a piezoresistive or resistive film is strained, the resistance of the film changes as a function of the strain. The resistance can be measured with an electrical circuit such as, for example, a Wheatstone bridge.

In certain embodiments, the resistive element may be measured by using a Wheatstone bridge. In such an example, a voltage Vg may be measured across the output of two parallel voltage dividers connected to a voltage supply Vs. One of the voltage dividers may include two resistors of known resistance R1 and R2, the other voltage divider including one resistor Ry, and the resistive element R. By comparing the voltage across the output of each voltage to the voltage of the voltage supply Vs., the differential changes to the resistances R, and Ry, can be measured. If the relationship between electrical resistance, temperature and mechanical strain of the material selected for the two resistive elements is known, the change in the differential strain Ex−Ey may be derived, with any change in the temperature of the two resistors largely cancelled if the two elements are at similar temperature while being subjected to differential strain due to the strain relief layer. A processor then may execute a set of instructions which use the values measured to calculate the mechanical strain due to the force on the surface while substantially cancelling the effects of temperature changes. In this way, a transparent piezoresistive or resistive film can be used as a strain gauge. If transparency is not required, then other film materials may be used, including, for example, Constantan and Karma alloys for the conductive film and a polyimide may be used as a substrate. Nontransparent applications include force sensing on track pads or behind display elements. In general, transparent and non-transparent force-sensitive films may be referred to herein as “force-sensitive films” or simply “films.”

In certain embodiments, pairs of voltage dividers may be used to form a full bridge, so as to compare the output of a plurality of sensors. In some embodiments, the currents and voltages across the sensing resistors may be measured, thus deriving their resistance and algorithms may be used to combine the results of such measurements, resulting in a cancellation of the temperature changes with resistance and extracting the magnitude of the strain. In this manner, error present as a result of temperature differences between sensors may be substantially reduced or eliminated without requiring dedicated error correction circuitry or specialized processing software. In alternate embodiments, both differential measurements of the resistor dividers and measurements of their individual resistances may be made to extract the corresponding differential strain, and also the temperature, and an algorithm may be applied to cancel the effects on strain measurement due to the differences in the thermal coefficient of expansion of the two sensor substrates.

In some embodiments, the force-sensitive film is patterned into an array of lines, pixels, or other geometric elements herein referred to as “film elements.” The regions of the force-sensitive film or the film elements may also be connected to sense circuitry using electrically conductive traces or electrodes. In general, the force-sensitive film exhibits a measurable change in an electrical property in response to a force being applied to the film. In one example, as a force is applied to the device, one or more of the film elements is deflected or deformed. Sense circuitry, in electrical communication with the one or more film elements or film electrodes, may be adapted to detect and measure the change in the electrical property (e.g., resistance) of the film due to the force applied. Based on the difference between the measured electrical property of the film and a known baseline for the same electrical property, an estimated amount of the applied force may be computed.

In some cases, the force-sensitive film may be patterned into pixel elements, each pixel element including an array of traces generally oriented along one direction. This configuration may be referred to as a piezoresistive or resistive strain gauge configuration. In general, in this configuration the force-sensitive-film may be composed of a material whose resistance changes in a known fashion in response to strain. For example, some materials may exhibit a change in resistance linearly in response to strain. Other materials may exhibit a change in resistance logarithmically or exponentially in response to strain. Still further materials may exhibit a change in resistance in a different manner. For example, the change in resistance may be due to a change in the geometry resulting from the applied strain such as an increase in length combined with decrease in cross-sectional area may occur in accordance with Poisson's ratio. The change in resistance may also be due to a change in the inherent resistivity of the material due to the applied strain. For example, the applied strain may make it easier or harder for electrons to transition through the material.

Poisson's ratio is the negative ratio of transverse to axial strain in a given material. When a material is compressed in one direction, it usually tends to expand in the other two directions perpendicular or parallel to the direction of force. Poisson's ratio ν(nu) is a measure of this effect. The Poisson ratio is the fraction (or percent) of expansion divided by the fraction (or percent) of compression, for small values of these changes. Conversely, if the material is stretched rather than compressed, it usually tends to contract in the directions transverse to the direction of stretching. This is a common observation when a rubber band is stretched, when it becomes noticeably thinner. The Poisson ratio will be the ratio of relative contraction to relative expansion. Certain materials shrink in the transverse direction when compressed (or expand when stretched) which will yield a negative value of the Poisson ratio.

The Poisson's ratio of a stable, isotropic, linear elastic material will generally be less than −1.0 and not greater than 0.5 due to the requirement that Young's modulus, the shear modulus and bulk modulus have positive values. Most materials have Poisson's ratio values ranging between 0.0 and 0.5. A perfectly incompressible material deformed elastically at small strains would have a Poisson's ratio of exactly 0.5. Most steels and rigid polymers when used within their design limits exhibit values of about 0.3. Rubber has a Poisson ratio of nearly 0.5. Cork's Poisson ratio is close to 0 showing very little lateral expansion when compressed. Some materials, mostly polymer foams, have a negative Poisson's ratio. That is, if these materials are stretched in one direction, they become thicker in perpendicular direction. Some anisotropic materials have one or more Poisson ratios above 0.5 in some directions.

Gauge factor (GF) or strain factor of a strain gauge is the ratio of relative change in electrical resistance R, to the mechanical strain ε. The gauge factor is defined as:

$$G F = \frac{\frac{Δ R}{R}}{ɛ} = \frac{\frac{Δ ρ}{ρ}}{ɛ} + 1 + 2 v \qquad Equation 1$$

### Where

ε=strain=ΔL/Lo
ΔL=absolute change in length
Lo=original length
ν=Poisson's ratio
ρ=Resistivity
ΔR=change in strain gauge resistance
R=unstrained resistance of strain gauge

One or more force-sensitive films may be integrated with or attached to a display element of a device, which may include other types of sensors. In one typical embodiment, a display element may also include a touch sensor included to detect the location of one or more user touch events. In certain embodiments, the force-sensitive film may be integrated with, or placed adjacent to, portions of a display element, herein generally referred to as a “display stack” or simply a “stack.” A force-sensitive film may be integrated with a display stack, by, for example, being attached to a substrate or sheet that is attached to the display stack. In this manner, as the display stack bends in response to an applied force, and through all the layers which have good strain transmission below the neutral axis, a tensile strain is transmitted.

Alternatively, the force-sensitive film may be placed within the display stack in certain embodiments. Although certain examples are herein provided with respect to force-sensitive film integrated with a display stack, in other embodiments, the force-sensitive film may be integrated in a portion of the device other than the display stack. Using a touch sensor in combination with the transparent force-sensitive film in accordance with some embodiments described herein, the location and magnitude of a touch on a display element of a device can be estimated.

For example, a deflection may produce a reduction or increase in the resistance or impedance of the force-sensitive film. A thermal gradient may also produce a reduction or increase in the resistance or impedance of the force-sensitive film depending on whether the gradient is positive or negative. As a result, the two effects may cancel each other out or amplify each other resulting in an insensitive or hypersensitive force sensor. A similar reduction or increase in the resistance or impedance of the force-sensitive film could also be produced by, for example, an increase in temperature of the force-sensitive film due to heat produced by other elements of the device. Generally, compression or tension of the force-sensing elements defined on the substrate of the force-sensing film creates strain on the force-sensing elements. This strain may cause a change in resistance, impedance, current or voltage that may be measured by associated sense circuitry; the change may be correlated to an amount of force that caused the strain. Accordingly, in some embodiments the force-sensing elements on the film may be considered or otherwise operate as strain gages. In still other examples, a change in temperature may physically change the geometry of the sensor. For example, a heated force-sensitive film may expand and a cooled force-sensitive film may contract. Separate and distinct from a change in the electrical properties as a result of temperature variation, mechanical changes may also impact the electrical performance of the sensor.

One solution to cancel the effect of temperature fluctuation is to provide more than one strain sensor in the same environmental conditions using one sensor as a reference point to compare the reading of the other sensor. In such a case, each of the two strain sensors may be constructed of substantially identical materials such that the reference sensor reacts to the environment in the same manner as the measurement sensor. Specifically, each of the two sensors may be adapted to have identical or nearly identical thermal coefficients of expansion. In this manner, the mechanical and geometric changes resulting from temperature changes may be compensated. In other words, because each sensor has the same or similar thermal coefficient of expansion, each sensor may expand or contract in a substantially identical manner. Accordingly, any effect to the electrical properties of either sensor as a result of temperature can be substantially compensated, cancelled, reduced or eliminated.

In some embodiments, a first sensor may be positioned or disposed below a surface which receives an input force. Positioned below the first sensor may be a compliant layer of thermally conductive material. Positioned below the compliant layer may be a second sensor which may function as a reference sensor. The entire stack may be environmentally sealed within a housing. In this manner, the thermal conductivity of the compliant layer may normalize the temperature between the first and second sensor and at the same time the compliance of the compliant layer may distribute or otherwise absorb a substantial portion of the deflection of the first sensor such that second sensor may not be deformed at all. In this manner, the second sensor may not experience any substantial tensile force. In other words, the complaint layer blocks or reduces the transmission of strain such that layers below the compliant layer experience reduced strain, and can produce a new neutral axis below the compliant layer. As a result, the second sensor may experience compressive forces in the lateral direction. Such compressive forces may have the opposite effect of the tensile strain in the layer on the first side of the compliant layer, and any electrical property of the second sensor may be opposite in sign from that of the first layer. When the signals from the two sensors are compared, the temperature signal appears as a common mode change, and the strain appears as a differential change.

FIG. 1 depicts an example electronic device 11 incorporating at least one transparent force sensor. The electronic device 11 may include a display 12 disposed within a housing 13. The display 12 may be any suitable display element that may include a stack of multiple layers including, for example, a liquid crystal display (LCD) layer, a cover glass layer, a touch input layer, and so on. Positioned within the layer stack may be at least one transparent force sensor. In many examples, each of the layers of the display 12 may be adhered together with an optically transparent adhesive. In other embodiments, each of the layers of the display 12 may be attached or deposited onto separate substrates that may be laminated or bonded to each other. The display stack may also include other layers for improving the structural or optical performance of the display, including, for example, a cover glass sheet, polarizer sheets, color masks, and the like. Additionally, the display stack may include a touch sensor for determining the location of one or more touches on the display 12 of the electronic device 11.

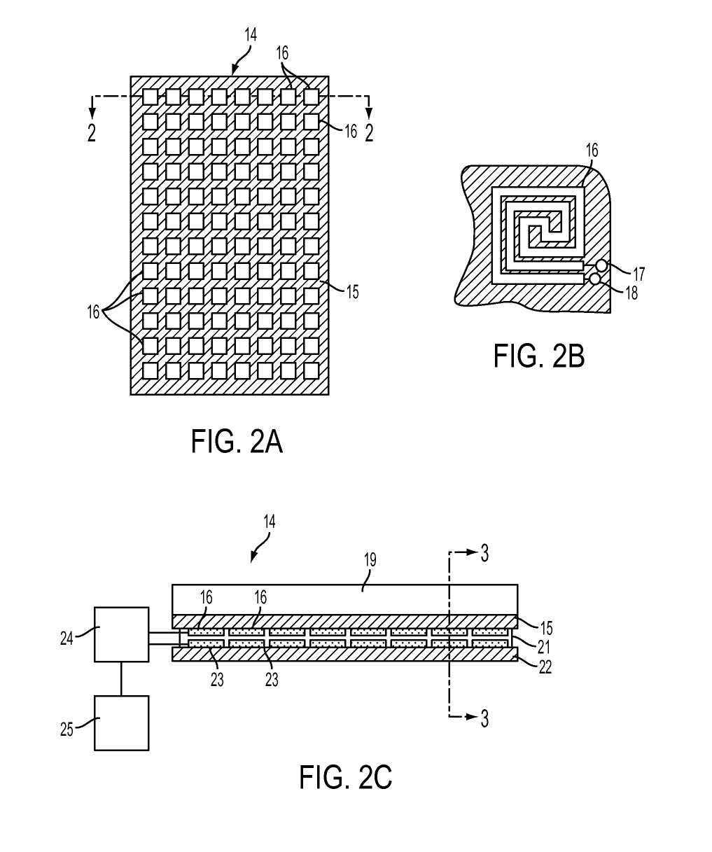

FIG. 2A depicts a top view of an example force-sensitive structure 14 including a grid of optically transparent force-sensitive films. The force-sensitive structure 14 includes a substrate 15 having disposed upon it a plurality of independent force-sensitive films 16, which may, in some embodiments be Transparent Conductive Electrodes (TCE) layers. In this example, the substrate 15 may be an optically transparent material, such as polyethylene terephthalate (PET). The force-sensing films 16 may be made from transparent conductive materials including, for example, polyethyleneioxythiophene (PEDOT), indium tin oxide (ITO), carbon nanotubes, graphene, nickel, silver nanowire, other metallic nanowires, and the like. In certain embodiments, force-sensing films 16 may be selected at least in part on temperature characteristics. For example, the material selected for the force-sensing films 16 may have a negative temperature coefficient of resistance such that, as temperature increases, the resistance decreases.

In this example, the force-sensing films 16 are formed as an array of rectilinear pixel elements, although other shapes and array patterns could also be used. In many examples, each individual force sensing film 16 may have a selected shape and/or pattern. For example, in certain embodiments, the force sensing film 16 may be deposited in a serpentine pattern, such as shown in FIG. 2B. The force sensing film 16 may include at least two electrodes 17, 18 for connecting to a sensing circuit. In other cases, the force sensing film 16 may be electrically connected to sense circuitry without the use of electrodes. For example, the force sensing film 16 may be connected to the sense circuitry using conductive traces that are formed as part of the film layer.

FIG. 2C depicts a side view of a portion of the example force-sensitive structure 14 of FIG. 2A taken along line 2-2. As depicted in this cross section, a first substrate 15 may be disposed below a force-receiving surface. The force-receiving surface 19 may be comprised of a material such as glass, which in one embodiment is sapphire glass. In some embodiments, the force-receiving surface 19 may be another layer within a display stack, such as a cover glass element. The force-receiving surface 19 may be made from a material having high strain transmission properties. In other words, the force-receiving surface 19 may be made from a hard or otherwise rigid material such as glass or metal such that a force received may be effectively transmitted through the force-receiving surface 19 to the layers disposed below. Below the force-receiving surface 19 and the first substrate 15 and the plurality of independent force-sensitive films 16 is a compliant layer 21. The compliant layer 21 may be made from any number of suitably compliant materials. For example, in some embodiments a low durometer elastomer may be used (in one example, the elastomer may have a durometer less than 25 Shore).

In other embodiments, the compliant layer 21 may be made from a mechanically compliant adhesive. In many embodiments, the compliant adhesive may be an optically clear adhesive. For example, the compliant layer 21 may be made from an acrylic adhesive having a thickness of about 50 microns. In other embodiments, a thicker or thinner layer of adhesive may be used. In one embodiment, the compliant layer 21 may be made from a number of independent layers, each having a different relative compliance. For example, a lower durometer adhesive may be layered atop a higher durometer adhesive. In still further embodiments, the material for the compliant layer 21 may be selected at least in part for its modulus of elasticity. For example, in certain embodiments, a particularly low modulus of elasticity such that the compliant layer 21 is exceptionally pliant. In further embodiments, the material selected for the complaint layer 21 may have a variable modulus of elasticity. For example, the complaint layer 21 may be particular compliant in one portion, and may be particularly non-complaint in another portion. In this manner, the complaint layer may be adapted to include a variable modulus of elasticity throughout its thickness.

In still further embodiments, the material for the complaint layer 21 may be layered to various thicknesses. The layering may augment the modulus of elasticity. For example, as a layering of the compliant layer 21 increases, the modulus of elasticity may increase. In a like manner, the modulus of elasticity of the compliant layer 21 may decrease if the material is applied thinly. In some examples, the compliant layer may be made from an acrylic adhesive applied to a thickness of 15 micrometers. In some embodiments, a 15 micrometer acrylic adhesive compliant layer may have a modulus of elasticity that is only fifty-five percent of the modulus of elasticity of the same layer at 125 micrometers. In this manner, the thickness, composition, and modulus of elasticity of the material selected for the complaint layer 21 may vary from embodiment to embodiment.

Below the compliant layer 21 is a second substrate 22 having a plurality of independent force-sensitive films 23 positioned thereon. Similarly to the first substrate 15, the second substrate 22 may be made from an optically transparent material, such as polyethylene terephthalate (PET). In this example, the force-sensing films 23 may be formed as an array of rectilinear pixel elements each aligned vertically with a respective one of the array independent force-sensitive films 16. In many examples, each individual force sensing film 23 may take a selected shape. For example, in certain embodiments, the force sensing film 23 may be deposited in a serpentine pattern, similar to the serpentine pattern shown for force sensing film 16 in FIG. 2B.

The force-sensitive films 16, 23 are typically connected to sense circuitry 24 that is configured to detect changes in an electrical property of each of the force-sensitive films 16, 23. In this example, the sense circuitry 24 may be configured to detect changes in the resistance of the force-sensitive film 16, 23, which can be used to estimate a force that is applied to the device. In some cases, the sense circuitry 24 may also be configured to provide information about the location of the touch based on the relative difference in the change of resistance of the force-sensitive films 16, 23.

The sensing circuitry 24 may be adapted to determine a difference between a force experienced by the force-sensitive film 16 and the force experienced by the force-sensitive film 23. For example, as described above, a force may be received at the force-receiving surface 19. As a result of the rigidity of the force-receiving surface 19, the force received may be effectively transferred to the first substrate 15. Because the force-sensitive film 16 is affixed to the first substrate 15, the force-sensitive film 16 experiences the force as well, and passes the force to the compliant layer 21. However, due to the compliance of the complaint layer 21, the compliant layer 21 may substantially absorb the force received from the force-sensitive film 16. As a result, the complaint layer 21 may not pass a substantial force to the force-sensitive film 23. Accordingly, the force-sensitive film 23 may not register that a force is present, even when force-sensitive film 16 does register that a force is present. As noted above, an additional function of the compliant layer 19 is to normalize the temperature between aligned force-sensitive film 16 and the respective one force-sensitive film 23. In this manner, the temperature of the force-sensitive film 16 and the temperature of force-sensitive film 23 may be substantially equal.

Sensing circuitry 24 may be connected to a control device 25 which may execute instructions and carry out operations associated with portable electronic devices as are described herein. Using instructions from device memory, controller 25 may regulate the reception and manipulation of input and output data between components of the electronic device. Controller 25 may be implemented in a computer chip or chips. Various architectures can be used for controller 25 such as microprocessors, application specific integrated circuits (ASICs) and so forth. Controller 25 together with an operating system may execute computer code and manipulate data. The operating system may be a well-known system such as iOS, Windows, Unix or a special purpose operating system or other systems as are known in the art. Control device 25 may include memory capability to store the operating system and data. Control device 25 may also include application software to implement various functions associated with the portable electronic device.

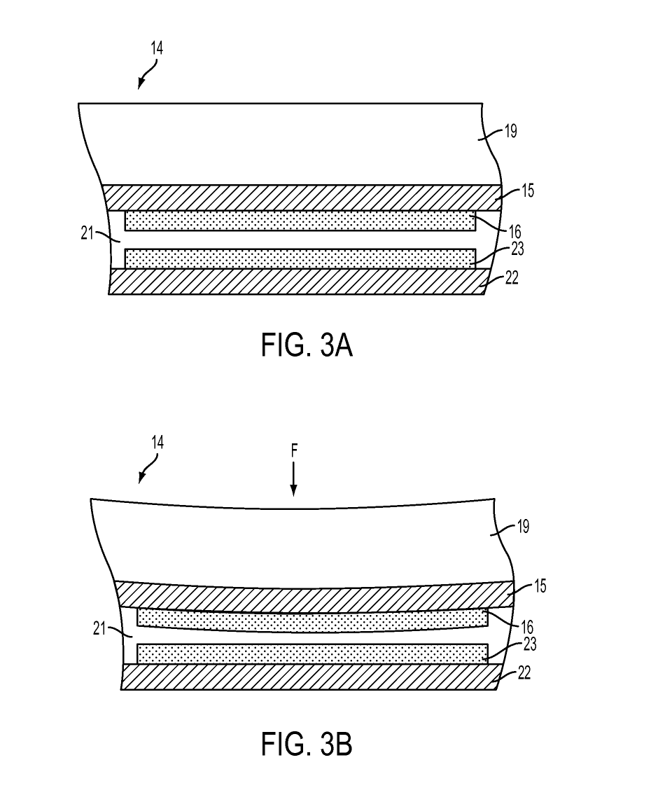

FIG. 3A depicts an enlarged detail side view of the example force-sensitive structure of FIG. 2B taken along line 3-3. As shown, a force-sensitive film 16 which may, in one embodiment, be indium tin oxide (ITO) is disposed along a bottom surface of the first substrate 15 which may, in one embodiment be polyethylene terephthalate (PET), which itself is adhered or otherwise affixed to a bottom surface of a force-receiving surface 19. Facing the first force-sensitive film 16 is a second force-sensitive film 23 which in one embodiment may be ITO, adhered to a second substrate 22 which may be PET. Positioned between the force-sensitive films 16, 23 is a compliant layer 21. When a force F is received, the force-receiving surface 19, the first substrate 15 and the force-sensing film 16 may at least partially deflect, as shown for example in FIG. 3B. As a result of the compliance of the compliant layer 21, the force sensing film 23 may not deflect in response to the force F.

Utilizing both the thermal conductivity and mechanical compliance of the complaint layer 19 allows certain embodiments to substantially reduce or eliminate any strain sensor drift resulting from temperature change, either locally or globally. For example, in a typical embodiment, the first 16 and second 23 force-sensitive films may be resistive elements electrically connected as a voltage divider. In certain embodiments the force-sensitive film 16 may be positioned as the ground-connected resistor of the voltage divider and the force-sensitive film 23 may be positioned as the supply-connected resistor of the voltage divider. Generally, the voltage at the midpoint of the force-sensitive film 16 and force-sensitive film 23 may be calculated by multiplying the supply voltage by the ratio of the ground-connected resistor to the total resistance (i.e., supply-connected resistor summed with the ground-connected resistor). In other words, the voltage at the midpoint of the voltage divider, Vₒᵤₜ may be found, in a simplified example, by using the equation

$${V}_{out} = {V}_{supply} ( \frac{{R}_{ground}}{{R}_{ground} + {R}_{supply}} ) \qquad Equation 2$$

Due to fact that the resistances of resistive elements R_{ground} and R_{supply} (or force-sensitive film 16 and force-sensitive film 23, respectively) change in response to force and in response to temperature, the resistance of either element may be calculated as a function of both force (i.e., strain) and as a function of temperature, using as a simplified example, the equation:

R_{measured}≅R_{baseline}(1+α·T_{actual})(1+g·e_{applied}) Equation 3

The approximation described by Equation 3 states that the base resistance R_{baseline} of either R_{ground} and R_{supply} may be altered by the both temperature and strain applied to the material. The effects of temperature changes may be approximated by the product of the temperature coefficient of resistance α of the material selected for the force-sensitive film, and the actual temperature T_{actual} of the element. Similarly, the effect of strain may be approximated by the product of the strain coefficient of resistance g and the strain applied E_{applied} to the element.

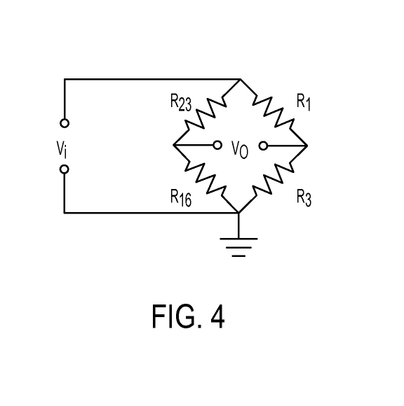

FIG. 4 depicts a simplified signal flow diagram of a temperature-compensating and optically transparent force sensor in the form of a Wheatstone bridge. In such an embodiment, a voltage Vₒ may be measured across the output of two parallel voltage dividers connected to a voltage supply V₀. One of the voltage dividers may include two resistors of known resistance R₁, R₃ and the other voltage divider may include two variable resistors R₁₆, R₂₃ that model the force and temperature variable resistance of the force-sensitive films 16, 23 as shown in, for example in FIGS. 2A-3. By substituting Equation 3 into Equation 2 after entering the known quantities V_{supply}, R_{baseline}, α, and g and measured quantities Vₒᵤₜ, the strain applied to each element ε₁₆ and ε₂₃ and the actual temperature of each element T₁₆ and T₂₃ are the only remaining unknown variables, which may be further simplified as a difference in strain Δε between the force-sensitive films 16, 23 and a difference in temperature ΔT between the force-sensitive films 16, 23. Because complaint layer 19 substantially normalizes the temperature between the force-sensitive films 16, 23, the difference in temperature ΔT may be functionally approximated as zero. Relatedly, the fact that the compliant layer 19 substantially reduces the strain experienced by the force-sensitive film 23, the strain ε₂₃ may be functionally approximated as zero. In this manner, the only remaining unknown is the strain ε₁₆ as experienced by the force-sensitive film 16. Accordingly, ε₁₆ may be solved for and passed to an electronic device as a force measurement through controller 25.

The strain ε₁₆ indicates the force F applied to compliant layer 19 as may be determined above through force sensing apparatus, circuitry 24 and controller 25. First force sensitive film 16 is made of an ITO layer. ITO layer 16 changes resistance according to its gauge factor g as indicated by the following equation which is the gauge factor Equation 1 ignoring temperature variation.

ΔR/R=gε

where R is the reference resistance, ΔR is the change in resistance and ε is the measured strain. The signal strength is related to g/4 due to the quarter bridge configuration of the Wheatstone Bridge. ITO has a gauge factor of about −1.5. The sensitivity of the gauge measurement is thus determined by

Vᵢ/Vₒ=gε/4

which equates to a total sensitivity of −0.375ε for this embodiment.

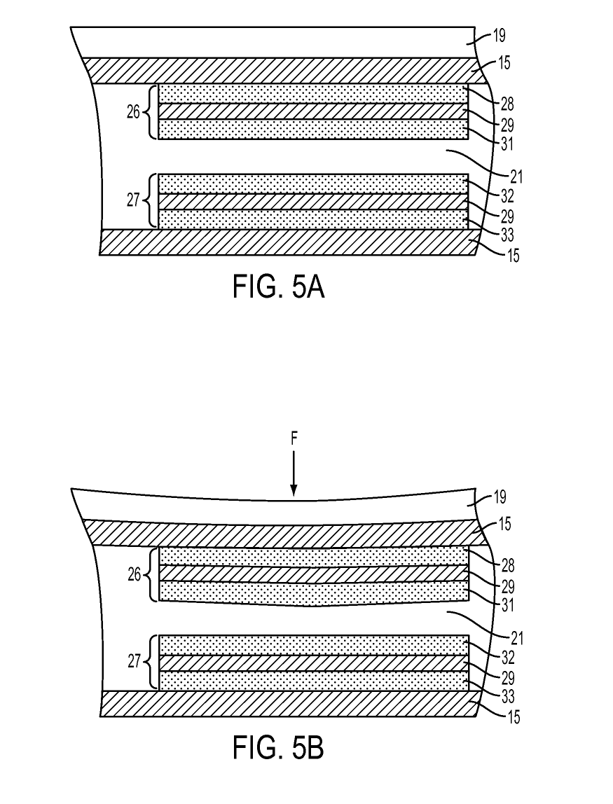

In order to improve the sensitivity of the strain gauge two different materials with opposite sign gauge factors may be used to increase signal strength. In one embodiment, two layers of transparent conductive electrodes (TCE) are used to increase sensitivity. Referring to FIG. 5A (as with FIG. 3A) a force receiving surface 19 is shown in another embodiment of a strain gauge configuration including two strain gauges layers 26, 27. First strain gauge layer 26 includes first substrate 15 which may, in one embodiment, be polyethylene terephthalate (PET) adhered or otherwise affixed to a bottom surface of force-receiving surface 19. A first TCE layer 28, which in one embodiment is ITO, is adhered to substrate 15. A passivation layer 29 separates TCE layer 28 from a second TCE layer 31 which, in one embodiment may be silver nanowire. As with the embodiment shown in FIG. 3A, a compliant layer 21 separates first 26 and second 27 strain gauge layers. Second strain gauge layer 27 includes a third TCE layer 32 which, in one embodiment, is the same material as TCE layer 31, that is, silver nanowire. A thin passivation layer 29, as described above, separates TCE layer 32 from a fourth TCE layer 33 which, in one embodiment, is the same material as first TCE layer 28, that is ITO. It should be expressly understood that TCE layers 28, 31, 32, and 33 in FIG. 5A may be any of the transparent conductive materials discussed above and are not limited to the specific material recited.

ITO and silver nanowire have gauge factors of opposite sign. As stated above, ITO has a gauge factor of negative 1.5. Silver nanowire, on the other hand, has a gauge factor of positive 2.5. The effect of employing these two materials adjacent one another is to increase signal strength. Referring to FIG. 5B, as with the previously described embodiment, the upper strain gauge 26 (including TCE layers 28 and 31 and passivation layer 29) senses the strain exerted by force F while lower strain gauge layer 27 (TCE layers 32, 33 and passivation layer 29) is used for temperature reference. In this embodiment, the sensitivity is increased to 1ε as shown by the equation:

Vᵢ/Vₒ=(g_{B}−g_{A})ε/4

where the difference in gauge factors (silver nanowire 2.5 and ITO−1.5) results in a sensitivity of:

Vᵢ/Vₒ=(2.5−(−1.5))ε/4 or

Vᵢ/Vₒ=ε

Thus, by adding a second TCE layer 31/32 to each sensing layer 26/27 respectively, a fourfold increase in sensitivity is achieved. The materials selected for each layer 28/33 or 31/32 may allow the sensitivity to be further increased. For example, nickel has a gauge factor of negative 12 while carbon nanotubes have a gauge factor of 5 and one or both may be used in some embodiments. Silicon may be used and has a gauge factor of 8. In another embodiment, graphene, having a gauge factor of 2.4, may also be used. By selecting these or other materials of different gauge factors, the sensitivity of the strain gauge measurement of force F may be increased. Even among the same materials, the gauge factor could be altered depending upon the crystalline structure. Because, passivation layer 29 is very thin as compared to the thickness of TCE layers 28, 31, 32, 33 the placement of layers 28, 31, 32, 33 may be altered in some embodiments. That is, layer 29 and 31 could be reversed and layers 32 and 33 could be reversed without departing from the embodiment disclosed.

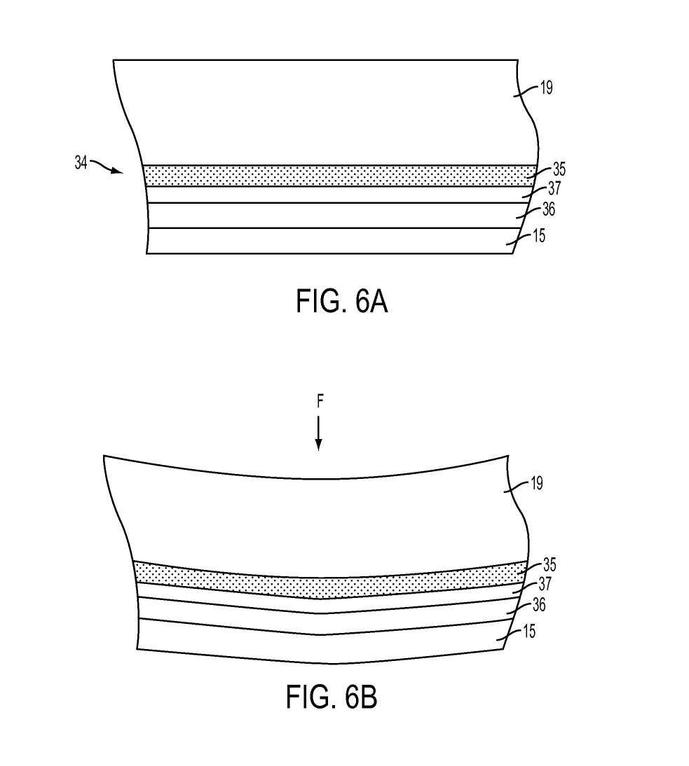

In another embodiment, referring to FIG. 6A, one strain gauge layer 34 is utilized below force sensing surface 19 rather than two as in the embodiment described with respect to FIG. 5A/B. Two materials with different gauge factors are used for TCE layers 35 and 36 and are adhered to PET substrate 15 with a passivation layer 37 therebetween. In this embodiment, two gauge equations for materials A and B (TCE layers 35 and 36 respectively) may be solved simultaneously for two unknowns (temperature θ and strain ε)

ΔR_{A}/R_{A}=g_{A}ε+α_{A}θ

ΔR_{B}/R_{B}=g_{B}ε+α_{B}θ

where R is resistance and ΔR is the measured change in resistance, g is the gauge factor and α is the known temperature coefficient for each of materials A and B. The ΔR is measured independently for layers 35 and 36 (materials A and B respectively). In this embodiment, the use of a Wheatstone Bridge which is shown in FIG. 4 is eliminated. In one embodiment, material A, TCE layer 35, may be a positive gauge factor material such as silver nanowire which increases resistance with increased strain and material B, TCE layer 36, may be a negative gauge factor material such as ITO which is less resistive if subjected to strain. By using materials with different gauge factors there is less inaccuracy in the measured strain.

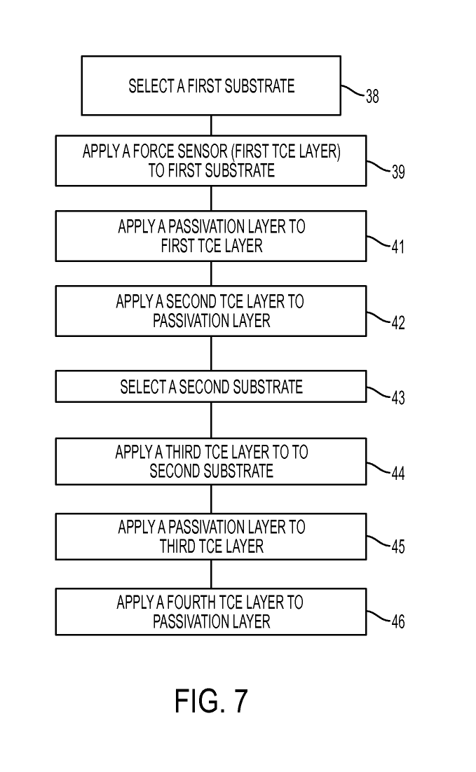

FIG. 7 is a process flow diagram illustrating example operations of a sample method of manufacturing a temperature-compensating and optically transparent force sensor. The process may begin at operation 38 in which a first substrate may be selected. After the first substrate is selected, a transparent force sensor (First TCE layer) may be applied thereto at operation 39. Subsequently, a passivation layer may be applied to the first TCE layer at operation 41 after which a second TCE layer may be applied to the passivation layer at operation 42. A second substrate may be selected at operation 43, after which a transparent force sensor (third TCE layer) may be applied at operation 44. At operation 45 a passivation layer may be applied to the third TCE layer from step 44 and, at operation 46 a fourth TCE layer may be applied to the passivation layer from step 45. At operation 47, the first and second substrates may be bonded or adhered together with an optically transparent adhesive between the TCE layers from steps 42 and 46. As discussed with respect to FIG. 5A, TCE layers 28, 31, 32, and 33 may, in one embodiment, be comprised of two materials with opposite sign gauge factors to increase the sensitivity of the resistance (force) measurement. It should be appreciated that the order of operations may vary between embodiments. For the embodiment described in FIG. 6, only steps 38-42 of the process are performed.

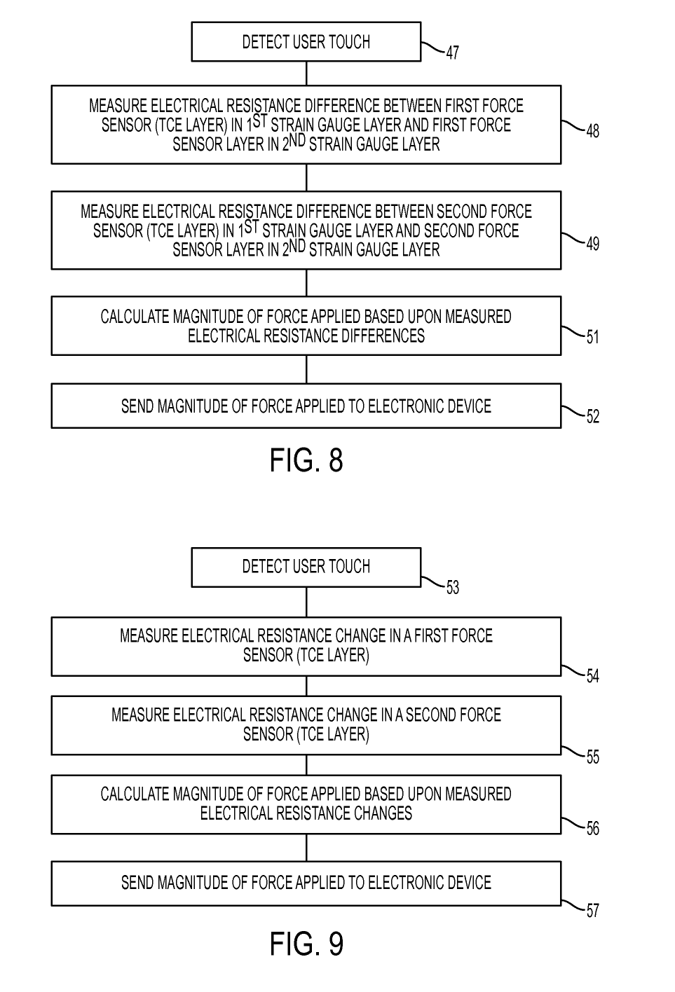

FIG. 8 is a process flow diagram illustrating example operations of a sample method of operating a temperature-compensating force sensor as described above. First, at operation 47 a location of a user touch may be identified. Next, at operation 48 an electrical resistance difference may be measured between a first force sensor material in the first strain gauge layer 26 and a first force sensor material in the second strain gauge layer 27. Next, at step 49 the electrical resistance difference is measured between a second force sensor material (TCE layer) in first strain gauge layer 26 and second force sensor material in the second strain gauge layer 27. At step 51 the magnitude of the applied force is calculated using the Wheatstone Bridge described in FIG. 4. The derived applied force is relayed to an electronic device at operation 52.

FIG. 9 is an additional process flow diagram illustrating example steps of a method of operating a temperature-compensating force sensor. First, at 53 a location of a user touch may be identified. Next, at 54 an electrical resistive change may be measured in a first force sensor (TCE layer). Next, at 55 an electrical resistive change may be measured in a second force sensor material with different gauge factor than the first force sensor layer (TCE layer). From this difference, at step 56 an applied force may be derived by solving the simultaneous gauge equations as described with respect to FIG. 6A. Thereafter, the measured force may be forwarded or otherwise relayed to the electronic device at 57.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

While various materials have been disclosed for TCE layers, passivation layers, substrate layers and compliant layers, it should be understood that the selection of these materials may be altered from the described embodiments without departing from the scope of the claims. Some materials may change temperature coefficients over time as they age and some materials may also change their modulus of elasticity over time. Other material property changes may be accounted for in selecting the most appropriate materials for the various layer embodiments.

What is claimed is:

1. An optically transparent force sensor adjacent to a force receiving surface comprising:
a substrate disposed below the force-receiving surface;
said substrate including a first and a second optically transparent electrode layer;
said first optically transparent electrode layer including a material having a different gauge factor from a gauge factor of a material comprising said second electrode layer; and
a passivation layer disposed between said first and second transparent electrode layers.

2. The force sensor of claim 1, wherein the first electrode layer material has a negative gauge factor and the second electrode layer material has a positive gauge factor.

3. The force sensor of claim 1, wherein the first transparent electrode layer material is indium-tin oxide.

4. The force sensor of claim 1, wherein the second transparent electrode layer material includes silver nanowire.

5. The force sensor of claim 1 further including a second substrate including:
a first and second optically transparent electrode layer;
said first electrode layer on said second substrate including a material having a different gauge factor from a gauge factor of material comprising said second electrode layer on said second substrate;
a passivation layer disposed between said transparent electrode layers; and
an adhesive layer between said second electrode layer of said second substrate and said second electrode layer of said first substrate.

6. The force sensor of claim 5, wherein the optically transparent first electrode layer on said second substrate has a negative gauge factor and said second optically transparent electrode layer on said second substrate has a positive gauge factor.

7. The force sensor of claim 5, wherein the first transparent electrode layer material on said second substrate includes indium-tin oxide.

8. The force sensor of claim 5, wherein the second transparent electrode layer material on said second substrate includes silver nanowire.

9. The force sensor of claim 6 wherein the adhesive layer comprises a thermally conductive and mechanically compliant material.

10. The force sensor of claim 6, wherein the adhesive layer comprises a pressure sensitive adhesive.

11. A method of manufacturing a force sensor comprising:
selecting a first substrate;
applying a first force-sensitive film to the first substrate;
applying a passivation layer to the first force-sensitive film; and
applying a second force-sensitive film to the passivation layer;
wherein the first force sensitive film and the second force sensitive film include materials with different gauge factors.

12. The force sensor of claim 11, wherein the first force sensitive film material has a negative gauge factor and the second force sensitive film layer material has a positive gauge factor.

13. The method of claim 11 further including:
selecting a second substrate;
applying a first force-sensitive film to the second substrate;
applying a passivation layer to the first force sensitive film on the second substrate;
applying a second force sensitive film to the passivation layer on the second substrate;
wherein the first force sensitive film on the second substrate and the second force sensitive film on the second substrate include materials with different gauge factors; and
bonding the first and second substrates with an adhesive layer;
wherein the adhesive layer comprises a thermally conductive and mechanically compliant material.

14. The method of claim 13, wherein the first and second force-sensitive films on the first and second substrates are made from at least one of the group consisting of an indium-tin oxide, carbon nanotubes, graphene, piezoresistive semiconductors, and piezoresistive metals.

15. The force sensor of claim 14, wherein the first force sensitive film material has a negative gauge factor and the second force sensitive film layer material has a positive gauge factor.

16. A method for detecting a magnitude of force applied to a portable electronic device comprising the steps of:
detecting a user touch on the electronic device;
measuring the electrical resistance difference between a first force sensor in first strain gauge layer and a first force sensor in a second strain gauge layer;
measuring the electrical resistance difference between a second force sensor in first strain gauge layer and a second force sensor in a second strain gauge layer;
calculating the magnitude of force applied by said user touch based upon said measured electrical resistance difference; and
sending said calculated force to said electronic device;
wherein said first force sensor and the second force sensor include materials with different gauge factors.

17. The method of claim 16 wherein the first force sensor has a negative gauge factor and the second force sensor has a positive gauge factor.

18. A method for detecting a magnitude of force applied to a portable electronic device comprising the steps of:
detecting a user touch on the electronic device;
measuring the electrical resistance change in a first force sensor;
measuring the electrical resistance change in a second force sensor;
calculating the magnitude of force applied by said user touch based upon said measured electrical resistance changes; and
sending said calculated force to said electronic device;
wherein said first force sensor and the second force sensor include materials with different gauge factors.

19. The method of claim 18 wherein the first force sensor includes a material with a negative gauge factor and the second force sensor includes a material with a positive gauge factor.

20. The method of claim 18 wherein the first and second force-sensor include at least one of the group consisting of an indium-tin oxide, carbon nanotubes, graphene, piezoresistive semiconductors, and piezoresistive materials.
